(19) United States
(12) Patent Application Publication
(10) Pub. No.: US 2003/0122364 A1
(43) Pub. Date: Jul. 3, 2003

(54) Structure of splash guard

(75) Inventor: Kazushige Muramatsu, Shizuoka (JP)

Correspondence Address: GREENBLUM & BERNSTEIN, P.L.C., 1950 ROLAND CLARKE PLACE, RESTON, VA, 20191, US

(73) Assignee: SUZUKI MOTOR CORPORATION,, Shizuoka (JP)

(21) Appl. No.: 10/302,855

(22) Filed: Nov. 25, 2002

(30) Foreign Application Priority Data
Dec. 28, 2001 (JP) P. 2001-398747

(51) Int. Cl. B62B 9/14

(52) U.S. Cl. 280/851

(57) ABSTRACT

A concave shaped portion is formed in a position corresponding to the jack attachment portion of a splash guard. The concave shaped portion is provided in only a lower surface portion of the splash guard, and has a notch portion obtained by cutting out an edge portion and a pair of ribs opposed separately from each other in the longitudinal direction of a vehicle body in the notch portion. The ribs are adjacent to the notch portion and enhance the rigidity of the notch portion, and furthermore, act as guides for jack attachment. By the concave shaped portion, a clearance S between the splash guard and a jack arm portion can be maintained sufficiently. The notch portion has such a minimum dimension that a jack head portion can be accommodated therein, and can minimize the amount of mud entering during running together with the ribs and a vertical wall.

### BACKGROUND OF THE INVENTION

1. Field of the Invention

The present invention relates to a structure of a splash guard in the jack-up portion of a vehicle such as an automobile.

2. Description of the Related Art

In an automobile to which a splash guard is attached, in some cases in which a body-side jack attachment portion is covered with a splash guard 21, a removable cap 22 is set to maintain a jack-up point as shown in FIGS. 8 and 9. More specifically, the cap 22 is removed to expose the flange of the body-side jack attachment portion and to attach a jack 7 when using the jack. By using the cap 22 as a guide, it is possible to confirm the position of the body-side jack attachment portion.

With such a structure, however, the number of parts and a cost are increased with the setting of the cap 22. Furthermore, there is a problem in that the quality of an external design is deteriorated and deal of time and labor is taken for the use of the jack.

In some cases in which a removable cap is not set as shown in FIGS. 10 and 11, a notch portion 24 is provided on the lower end of a splash guard 23. By enlarging the notch portion 24, it is possible to enhance a workability when using the jack. However, there is a problem in that the amount of mud entering the splash guard 23 from the notch portion 24 is increased when the notch portion 24 is enlarged.

### SUMMARY OF THE INVENTION

The invention has been made in consideration of such circumstances and has an object to provide a structure of a splash guard capable of easily attaching a jack and preventing mud from entering therein without deteriorating the quality of an external design.

The invention provides a structure of a splash guard which is attached to a vehicle body to cover a side sill outer panel up to the vicinity of a jack attachment portion, wherein a concave shaped portion on a vehicle body side is provided in a lower part of the splash guard corresponding to the jack attachment portion.

The concave shaped portion is positioned on an inside in a width direction of a lower end corner portion of the splash guard. A notch portion is provided in a tip edge portion of the concave shaped portion and a length in a longitudinal direction of the vehicle body in the notch portion is smaller than a length in the longitudinal direction of the vehicle body in the concave shaped portion.

The concave shaped portion is provided with a rib extended in the width direction on an outside in the width direction from the notch portion. The rib may be adjacent to the notch portion and be extended outward in the width direction from the edge portion. A height of a protrusion of the rib is increased toward the jack attachment portion.

A vertical wall portion is provided adjacently to the concave shaped portion in the longitudinal direction of the vehicle body.

### BRIEF DESCRIPTION OF THE DRAWINGS

FIG. 1 is a side view showing an automobile to which the structure of a splash guard according to an embodiment of the invention can be applied.

FIG. 2 is a perspective view seen in an arrow A of FIG. 1.

FIG. 3 is a sectional view taken along a line III-III in FIG. 2.

FIG. 4 is a side view seen in an arrow IV of FIG. 3.

FIG. 5 is a cross sectional view partially showing a state in which the splash guard is attached to a vehicle body.

FIG. 6 is a cross sectional view partially showing the state in which the splash guard is attached to the vehicle body.

FIG. 7 is a perspective view seen in the arrow A of FIG. 1 in the case in which a variant is applied.

FIG. 8 is a perspective view showing the conventional case seen in the arrow A of FIG. 1,

FIG. 9 is a sectional view taken along a line IX-IX in FIG. 8.

FIG. 10 is a perspective view showing another conventional case seen in the arrow A of FIG. 1.

FIG. 11 is a sectional view taken along a line XI-XI in FIG. 10.

### DETAILED DESCRIPTION OF THE PREFERRED EMBODIMENTS

An embodiment of a structure of a splash guard according to the invention will be described with reference to the drawings.

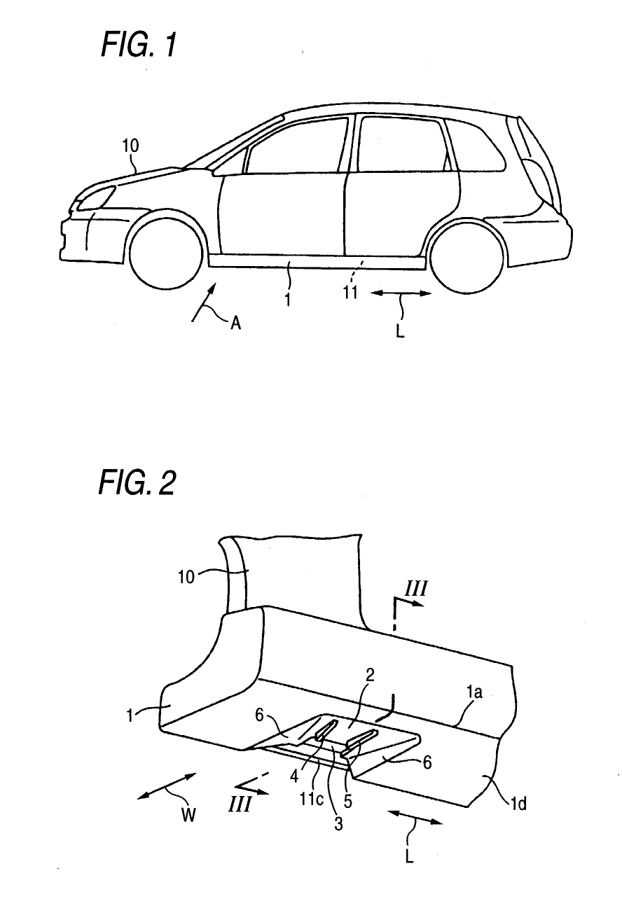

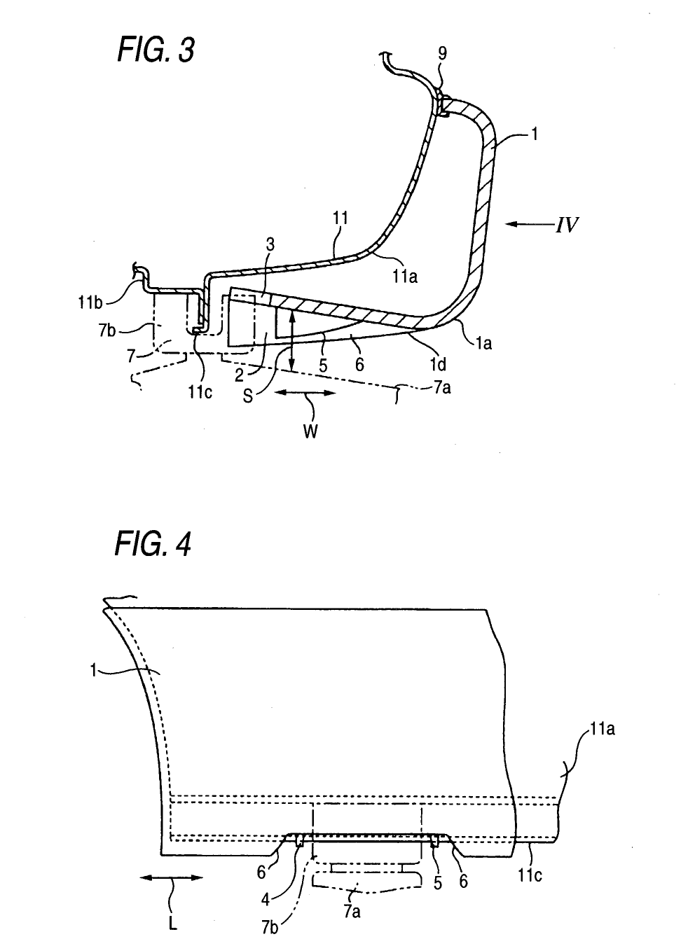

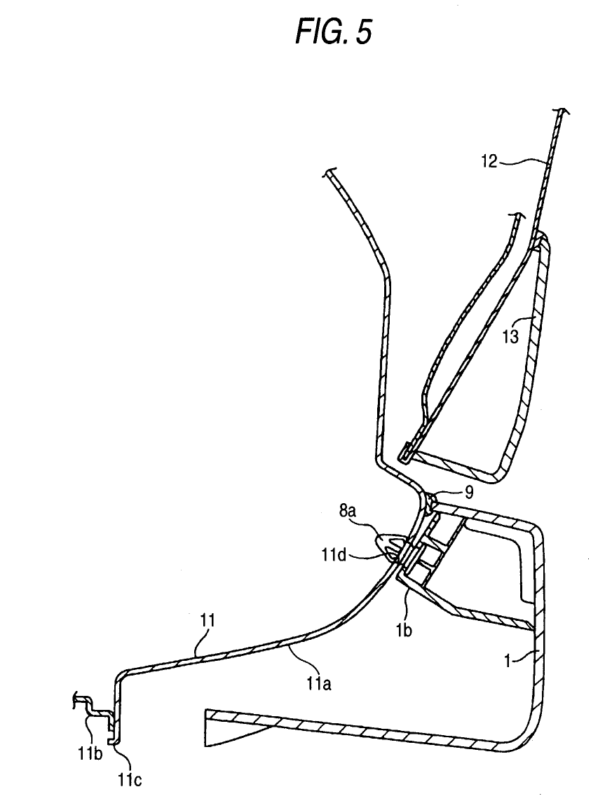

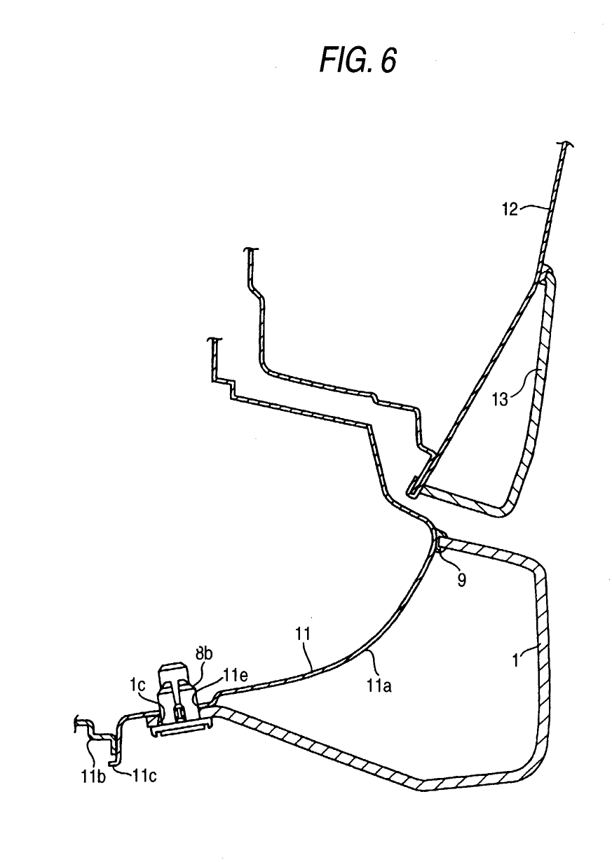

FIG. 1 shows a state in which a side splash guard 1 is attached to a side sill 11 of a vehicle. In this embodiment, the splash guard 1 is attached to an automobile 10. The side sill 11 has a flange portion 11c constituted by a side sill outer panel (a side body outer panel) 11a and a side sill inner panel 11b as shown in FIGS. 5 and 6, and a jack 7 is attached to the flange portion 11c as shown in FIG. 3.

As shown in FIGS. 2 and 3, the splash guard 1 has a concave shaped portion 2 around a jack-up portion in a position corresponding to a jack attachment portion (a jack-up point). The concave shaped portion 2 has a notch portion 3 formed by cutting out an edge portion, and a pair of ribs 4 and 5 opposed separately from each other in a longitudinal direction L (see FIG. 2) of a vehicle body in the notch portion 3.

As shown in FIG. 3, the concave shaped portion 2 is formed on the inside in a width direction W of a lower end corner portion 1a of the splash guard 1. More specifically, the concave shaped portion 2 is positioned in only a lower surface portion 1d of the splash guard 1. Therefore, the concave shaped portion 2 cannot be seen in a normal state so that the external design of the splash guard 1 is not damaged. By providing the concave shaped portion 2, moreover, a clearance S can be sufficiently maintained between the side splash guard 1 and a jack arm portion 7a. The notch portion 3 is set to have such a minimum size that a jack head portion 7b can be accommodated therein, and it is possible to minimize the amount of mud entering in an inner part during running. The mud can be further prevented from entering by vertical wall portions 6 and 6 provided in the longitudinal direction L of the vehicle body adjacently to the concave shaped portion 2 respectively as shown in FIG. 2.

As shown in FIGS. 2 and 4, the positions of the ribs 4 and 5 are set in the longitudinal direction of the notch portion 3 and are adjacent to the notch portion 3. By the ribs 4 and 5, a jack-up worker can confirm the position of the jack attachment portion more easily. Accordingly, the jack head portion 7b can be attached to the notch portion 3 to be set in a normal attachment position. Thus, the ribs 4 and 5 act as guides for jack attachment. Moreover, the ribs 4 and 5 can prevent the mud from entering still more. Furthermore, the ribs 4 and 5 can increase the rigidity of the notch portion 3.

Next, the assembly of the splash guard 1 will be described with reference to FIGS. 5 and 6. Each of FIGS. 5 and 6 is a cross sectional view partially showing a state in which the splash guard is attached to a vehicle body. As shown in FIG. 5, a clip attachment seat 1b is provided in an upper part on the internal surface side of the splash guard 1, and a clip 8a attached to the clip attachment seat 1b is inserted in an attachment hole 11d provided on the side sill outer panel 11a, thereby attaching the upper part of the splash guard 1. As shown in FIG. 6, moreover, a clip 8b is inserted in an attachment hole 1c provided on the lower part of the splash guard 1 and an attachment hole 11e provided on the side sill outer panel 11a, thereby attaching the lower part of the splash guard 1. The splash guard 1 is attached to the side sill outer panel 11a with the clips 8a and 8b at a regular interval in a longitudinal direction thereof (the longitudinal direction L of the vehicle body).

As shown in FIGS. 5 and 6, a protector 9 is provided between the upper end face of the splash guard 1 and the outer surface of the side sill outer panel 11a in order to prevent the damage thereof and the generation of noises. Moreover, an exterior part 13 is provided in a lower part on the outer surface side of a door outer panel 12.

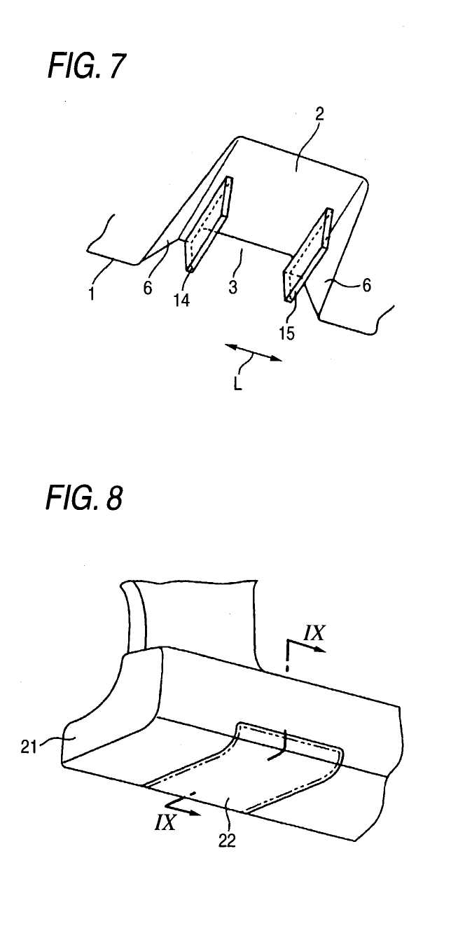

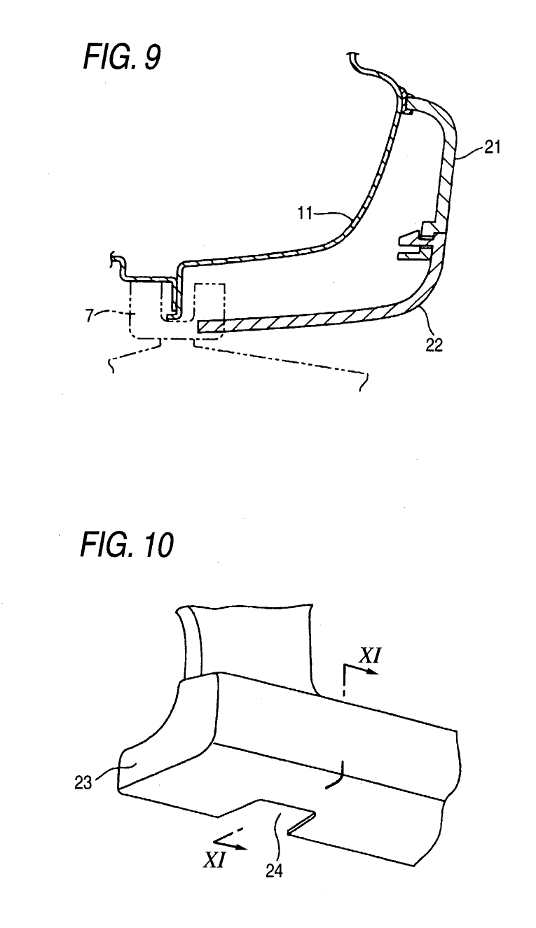

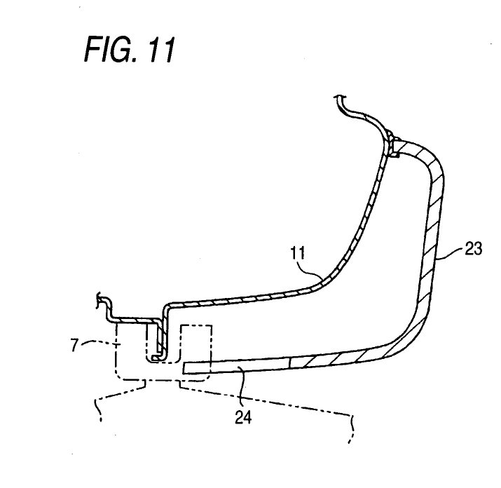

While the embodiment has been described with reference to FIGS. 1 to 6, various deformations can be made. For example, if a pair of ribs 14 and 15 in the concave shaped portion are adjacent to the notch portion 3 and are caused to overlap with the notch portion 3 to be extended outward in the width direction W from the edge portion as shown in FIG. 7, it is possible to more effectively prevent mud from entering.

Although the concave shaped portion is provided corresponding to the jack attachment portion on the front side in the embodiment, the invention is not restricted thereto but can also be applied to a jack attachment portion on the rear side.

The structure of the splash guard according to the invention which is attached to a vehicle body to cover a side sill outer panel up to the vicinity of a jack attachment portion, a concave shaped portion on the vehicle body side is provided in the lower part of the splash guard corresponding to the jack attachment portion. Consequently, the jack attachment portion can easily be confirmed and mud can be prevented from entering therein.

What is claimed is:

1. A structure of a splash guard which is attached to a vehicle body to cover a side sill outer panel up to the vicinity of a jack attachment portion, comprising:
a concave shaped portion provided in a lower part of the splash guard corresponding to the jack attachment portion and concaved on a vehicle body side.

2. The structure according to claim 1,
wherein the concave shaped portion is positioned on an inside in a width direction of the vehicle body in a lower end corner portion of the splash guard.

3. The structure according to claim 1,
wherein the concave shaped portion includes a notch portion provided in an edge portion of the concave shaped portion, and
wherein a first length in a longitudinal direction of the vehicle body in the notch portion is smaller than a second length in the longitudinal direction of the vehicle body in the concave shaped portion.

4. The structure according to claim 3,
wherein the concave shaped portion includes a rib provided on an outside from the notch portion in a width direction of the vehicle body and extended in the width direction.

5. The structure according to claim 3,
wherein the concave shaped portion includes a rib adjacent to the notch portion and extended outward in the width direction of the vehicle body from the edge portion.

6. The structure according to claim 5,
wherein the rib overlaps the notch portion in the width direction.

7. The structure according to claim 4,
wherein a height of a protrusion of the rib is increased toward the jack attachment portion.

8. The structure according to claim 1, further comprising:
a vertical wall portion provided adjacently to the concave shaped portion in the longitudinal direction of the vehicle body.
